(19) United States
(12) Patent Application Publication
(10) Pub. No.: US 2006/0194690 A1
(43) Pub. Date: Aug. 31, 2006

(54) Alumina-based ceramic material and production method thereof

(76) Inventor: Hideyuki Osuzu, SHOWA DENKO K.K. YOKOHAMA PLANT (JP)

Correspondence Address: SUGHRUE MION, PLLC, 2100 PENNSYLVANIA AVENUE, N.W., SUITE 800, WASHINGTON, DC, 20037, US

(21) Appl. No.: 10/546,766

(22) PCT Filed: Feb. 23, 2004
(86) PCT No.: PCT/JP04/02079

§ 371 Date: Aug. 24, 2005

(51) Int. Cl. C04B 35/117

(52) U.S. Cl. 501/127; 501/134

(57) ABSTRACT

The present invention relates to an alumina-based ceramic material mainly comprising alumina, produced by shaping mixture of manganese-titanium composite oxide and a vanadium oxide and sintering the resulting shaped article, and a production method therefor. The alumina-based ceramic material in the present invention can be applied to uses for dielectric porcelain, dielectric antenna and dielectric resonator and a supporting stand therefor, dielectric filter, dielectric duplexer, and communication device.

### CROSS-REFERENCE TO RELATED APPLICATIONS

This is an application filed pursuant to 35 U.S.C. Section 111(a) with claiming the benefit of U.S. provisional application Ser. No. 60/450,713 filed Mar. 3, 2003 and U.S. provisional application Ser. No. 60/515,667 filed Oct. 31, 2003 under the provision of 35 U.S.C. 111(b), pursuant to 35 U.S.C. Section 119(e) (1).

### TECHNICAL FILED

The present invention relates to a method for producing an alumina-based ceramic material mainly comprising alumina (aluminum oxide (Al₂O₃)), which is used for an inorganic multilayer wiring substrate having mounted thereon large-scale integration (LSI), an integrated circuit (IC) or a chip part, or for a communication device used in a high frequency region such as microwave or milliwave. More specifically, the present invention relates to a method for producing an alumina-based ceramic material, which is sinterable at a low temperature to have a high density and high strength as a sintered body, and is low in dielectric loss with excellent temperature stability of the resonance frequency, to alumina-based ceramic material obtainable by the method and to uses thereof.

### BACKGROUND ART

With the recent progress made in the field of electronic equipments such as information communication equipments, including cellular phones gaining widespread use, downsizing of device with high-speed and high-frequency performance is being demanded. In such a product, a low dielectric constant substrate, a multilayer-wiring substrate, a supporting stand or the like (hereinafter, these are collectively and simply referred to as “substrate”) is used.

As main types of the substrate for electronic equipments, an organic substrate mainly comprising an organic material such as glass epoxy, and an inorganic substrate mainly comprising a ceramic such as alumina or a glass are used. Inorganic substrates, generally having properties such as high heat resistance, high thermal conductance, low thermal expansion and high reliability, are widely used. Inorganic multilayer-wiring substrates can be roughly classified into high temperature co-fired ceramics type (hereinafter, abbreviated as “HTCC”) and low temperature co-fired ceramics type (hereinafter, abbreviated as “LTCC”).

HTCC uses Al₂O₃, AlN, BeO, SiC—BeO or the like as the base material. Such a ceramic material is produced by shaping a powdery starting material and firing it at a high temperature of 1,600° C. or more. Therefore, only Mo, W or the like having a high melting point can be used as the material for a conductor formed inside the multilayer-wiring substrate, which imposes limitation on fine-patterning for circuit design.

As a conductor, Mo and W have a defect that the resistivity is high. Ag and Cu, which have low resistivity, melt on firing at a high temperature due to their low melting point and cannot be used as a wiring conductor. Furthermore, the firing temperature of 1,600° C. or more is a great energy loss.

On the other hand, since LTCC can be fired at a relatively low temperature of approximately 1,000° C., a conductor having a low conductor resistance and capable of fine patterning, such as Ag and Cu, can be used. LTCC contains a glass having a low melting point as the main starting material, and examples of LTCC include composites such as lead borosilicate glass+alumina and borosilicate glass+cordierite, and other various composites.

LTCC is thus a material comprising a ceramic starting material such as alumina made firable at a low temperature at which Ag or Cu does not melt. In preparing LTCC, ceramic material is rendered to be firable at a low temperature by mixing a glass material having a low melting point so that Ag or Cu having low resistance can be used as inner conductor. For this advantage of LTCC, material for the mainstream inorganic substrate is now shifting from HTCC to LTCC.

As LTCC, a ceramic material comprising aluminum oxide as the main component and further containing a combination of metal oxides capable of forming a constant ratio compound having a liquid-phase producing temperature of 700 to 1,060° C., such as manganese oxide and vanadium oxide, vanadium oxide and magnesium oxide, or manganese oxide and bismuth oxide, is known (see, for example, JP-A-11-157921 (The term “JP-A” used herein means publication of an unexamined Japanese patent application)).

Also, a ceramic material containing metal elements Al, Ti and Mn, not forming an Al₂TiO₅ phase as determined by X-ray diffraction analysis, being firable at 1,310° C. or less, satisfying the relationship that x and y are in the range of 3.0≦x≦9.0 and 0.1≦y≦1.0 when represented by a compositional formula (100−x−y)AlO_{3/2}−xTiO₂−yMnO (wherein x and y each is mol %), and showing a Q value of 10,000 or more at 10 GHz is known (see, for example, JP-A-2002-80273)

However, not only conventional substrates using a glass as the main starting material but also these LTCC substrates have a problem that the density or strength of the substrate is not sufficiently high, and it is difficult for LTCC to apply to electronic equipments, particularly information communication devices required to have reliability and impact resistance.

In order to solve these problems, an object of the present invention is to provide a method for producing an alumina-based ceramic material sinterable at a low temperature to give a sintered body with high-density and high-strength, and ensuring excellent temperature stability of the resonance frequency with low dielectric loss.

### DISCLOSURE OF INVENTION

As a result of extensive investigations to attain the above-described object, the present inventors have accomplished the present invention. More specifically, the present invention comprises the followings:

(1) A method for producing an alumina-based ceramic material comprising alumina as the main component, comprising mixing a manganese and titanium composite oxide and a vanadium oxide with the main component alumina, shaping the mixture and sintering the resulting shaped article.

(2) A method for producing an alumina-based ceramic material comprising alumina as the main component, comprising mixing a manganese and titanium composite oxide and a vanadium oxide with the main component alumina, granulating the mixture, shaping the granules and sintering the resulting shaped article.

(3) The method for producing an alumina-based ceramic material as described in (1) or (2) above, wherein the manganese-titanium composite oxide comprises MnTiO₃.

(4) The method for producing an alumina-based ceramic material as described in any one of (1) to (3) above, wherein the vanadium oxide comprises V₂O₅.

(5) The method for producing an alumina-based ceramic material as described in any one of (1) to (4) above, wherein an alumina material having an average particle size of 0.3 to 1 μm is used.

(6) The method for producing an alumina-based ceramic material as described in any one of (1) to (5) above, wherein the manganese-titanium composite oxide has a BET specific surface area of 1 m²/g or more.

(7) The method for producing an alumina-based ceramic material as described in any one of (1) to (6) above, wherein the vanadium oxide has an average particle size of 0.5 to 3

(8). The method for producing an alumina-based ceramic material as described in any one of (1) to (7) above, wherein the mixing is carried out with a grinding aid.

(9) The method for producing an alumina-based ceramic material as described in any one of (1) to (8) above, wherein the amount of the manganese-titanium composite oxide added is within a range of 6 to 10 mass % and the amount of the vanadium oxide added is within a range of 2 to 5 mass % based on the total mass of the material.

(10) The method for producing an alumina-based ceramic material as described in any one of (1) to (9) above, wherein the alumina-based ceramic material comprises an oxide of an alkaline earth metal in an amount of 2 mass % or less % based on the total mass of the material.

(11) The method for producing an alumina-based ceramic material as described in any one of (1) to (10) above, wherein the sintering temperature is within a range of 900 to 1,100° C.

(12) The method for producing an alumina-based ceramic material as described in any one of (1) to (11) above, wherein the sintering is performed after a circuit is wired with Ag or Cu on the surface of the shaped article.

(13) An alumina-based ceramic material produced by using the production method described in any one of (1) to (12) above.

(14) An alumina-based ceramic material comprising Mn₂V₂O₇ crystal phase.

(15) The alumina-based ceramic material as described in (14) above, comprising MnTiO₃ crystal phase.

(16) The alumina-based ceramic material as described in (14) or (15) above, comprising VO₂ crystal phase.

(17) The alumina-based ceramic material as described in any one of (14) to (16) above, comprising TiO₂ crystal phase.

(18) An alumina-based ceramic material comprising alumina as the main component, comprising crystal phases of MnTiO₃, VO₂ and TiO₂.

(19) The alumina-based ceramic material as described in any one of (14) to (18) above, wherein the crystal phase measured by the X-ray diffraction measurement, the d₂₀₁ peak intensity of Mn₂V₂O₇ in the vicinity of 2θ=29° is larger than the d₁₀₄ peak intensity of MnTiO₃ in the vicinity of 2θ=32°, in the Cu-Kα ray diffraction peak.

(20) The alumina-based ceramic material as described in any one of (14) to (19) above, wherein the relative density of the alumina-based ceramic material is 94% or more at sintering temperature of 1,000° C.

(21) The alumina-based ceramic material as described in any one of (14) to (20) above, wherein the melt viscosity of the alumina-based ceramic material is from 10⁸ to 10¹⁰ (poise) in the temperature region of 900 to 1,000° C.

(22) The alumina-based ceramic material as described in any one of (14) to (21) above, wherein the endothermic peak of the alumina-based ceramic material is detected in the vicinity of 1,000° C. (retain) in differential thermal analysis.

(23) A multilayer wiring substrate comprising an insulating layer formed of the alumina-based ceramic material described in any one of (13) to (22) above, and a copper (Cu) or silver (Ag) conductor.

(24) A dielectric porcelain comprising the alumina-based ceramic material described in any one of (13) to (22) above.

(25) A dielectric antenna comprising the alumina-based ceramic material described in any one of (13) to (22) above, the alumina-based ceramic material having on the surface thereof a radiation electrode and a ground electrode

(26) A dielectric resonator comprising a dielectric porcelain disposed on a supporting stand formed of the alumina-based ceramic material described in any one of (13) to (22) above, and an input/output terminal disposed by electromagnetic-field connection in both sides of the dielectric porcelain.

(27) A dielectric filter for communication devices, using the dielectric porcelain described in (24) above.

(28) A dielectric duplexer comprising at least two dielectric filters, input/output connecting means connected to each dielectric filter, and antenna connecting means commonly connected to the dielectric filters, wherein at least one of the dielectric filters is the dielectric filter described in (27) above.

(29) A communication device comprising a dielectric duplexer, a transmission circuit connected to at least one input/output connecting means of the dielectric duplexer, a receiving circuit connected to at least one input/output connecting means different from the input/output connecting means connected to the transmission circuit, and an antenna connected to the antenna connecting means of the dielectric duplexer, wherein the dielectric duplexer is the dielectric duplexer described in (28) above.

### BRIEF DESCRIPTION OF DRAWINGS

FIG. 1 is a perspective view showing one example of the dielectric antenna of the present invention.

FIG. 2 is an arrangement plan showing the dielectric resonator including the supporting stand of the present invention.

FIG. 3 is a perspective view showing one example of the dielectric resonator of the present invention.

FIG. 4 is a perspective view showing one example of the dielectric filter of the present invention.

FIG. 5 is a a perspective view showing one example of the dielectric duplexer of the present invention.

FIG. 6 is a block diagram showing one example of the communication device of the present invention.

FIG. 7 is a chart showing the results in the measurement of viscosity of the sintering aid of Example 12.

FIG. 8 is a chart showing the results in the measurement of viscosity of the sintering aid of Comparative Example 5.

FIG. 9 is a TG-DTA curve showing the results in the thermal analysis measurement of the sintering aid of Example 12.

FIG. 10 is an X-ray diffraction pattern of the sintering aid of Example 12 after firing at 1,000° C.

FIG. 11 is an X-ray diffraction pattern of the sintering aid of Comparative Example 5 after firing at 1,000° C.

### DETAILED DESCRIPTION OF INVENTION

The present invention comprises a method for producing an alumina-based ceramic material mainly comprising alumina, characterized in that alumina as the main component is mixed with starting material powder comprising a manganese-titanium composite oxide and a vanadium oxide as sintering aid, and the mixture is then shaped and sintered.

The term “mainly comprising alumina” means that the percentage of alumina occupying in the produced alumina-based ceramic material is preferably 85 mass % or more, more preferably 86 mass % or more. If the percentage of alumina is less than 85 mass %, the properties analogous to the original alumina are less exhibited.

The manganese-titanium composite oxide for use in the present invention means an oxide which manganese and titanium are optionally comprised with an oxide. A particularly preferred example thereof is MnTiO₃.

MnTiO₃ is produced, for example, by mixing MnCO₃ and TiO₂ each in a powder form at a molar ratio of 1:1 and firing the mixture at a temperature of 1,000 to 1,200° C. MnTiO₃ used in the present invention may have Mn or Ti partially substituted by metal element such as Mg, Fe, Ca, Pd, Na, Li, Co, Ce, Cd, Cr or W.

The technique of adding manganese oxide and titanium oxide to alumina is described in JP-A-2002-80273, however, the present invention is characterized by adding these as a previously prepared composite oxide. Although the reason is not clearly known, when it is formed into a composite oxide, the oxide is present as an MnTiO₃ crystal phase but not as a solid solution even after the sintering and therefore, the density of the sintered body increases. As a result, the heat conductivity is enhanced and the dielectric loss is reduced.

The alumina-based ceramic material in the present invention, obtained by mixing the main component alumina with a starting material powder comprising a manganese-titanium composite oxide and a vanadium oxide, then shaping the mixture and sintering the resulting shaped article, is characterized not only by the relative density of 94% or more at 1,000° C. but also by its property that, due to scarce growth of alumina particles, the area where the fine particles contact each other increases, resulting in enhancement of strength of the sintered body. The particle size (the number average size by the Scanning Electron Microscope(SEM) observation) of alumina particles after the sintering is from 1 to 2 times, preferably on the order of 1 to 1.7 times, more preferably on the order of 1 to 1.5 times the particle size (D50 as measured by the laser diffraction scattering method) of alumina particles before sintering.

The mixture of a manganese-titanium-based composite oxide and a vanadium oxide, which is mixed as a sintering aid in the present invention, is characterized by having an endothermic peak when held at a temperature in the vicinity of 1,000° C.

When the mixture of a manganese-titanium-based composite oxide and a vanadium oxide, mixed in as a sintering aid in the present invention, was held at 1,000° C., then cooled and subjected to X-ray diffraction measurement, it was revealed that an Mn₂V₂O₇ phase, an MnTiO₃ phase, a VO₂ phase and a TiO₂ phase were contained as crystal phases. Also, the d₂₀₁ peak intensity (based on the peak height) of the Mn₂V₂O₇ phase in the vicinity of 2θ=29° (Cu-Kα) detected by the X-ray diffraction measurement is larger than the d₁₀₄ peak intensity (based on the peak height) of the MnTiO₃ phase in the vicinity of 2θ=32°(Cu-Kα). The former is preferably on the order of 1.1 to 6 times, more preferably on the order of 1.5 to 5 times the latter.

Although it is not clearly known what effects the mixture of a manganese·titanium-based composite oxide and a vanadium oxide, which is mixed as a sintering aid in the present invention, have on the sintering process of alumina particles, the following facts infer that the presence of crystal phases in the ratio as in the present invention gives a preferred effect in the sintering process:

(1) MnO and V₂O₅ generate a liquid phase from about 800° C. and the liquid phase generates an Mn₂V₂O₇ phase during cooling, however, when only MnO and V₂O₅ are used as the sintering aid, sintering of alumina particles with each other does not successfully proceed due to bad wettability between the alumina particle surface and the fused solution, and

(2) TiO₂ has good wettability to alumina particles.

Therefore, in order to analyze the sintering process of the alumina-based ceramic material of the present invention, the viscosity of the shaped article in a high-temperature melted state was measured using a parallel plate pressure viscometer. The alumina-based ceramic material of the present invention has a viscosity of 10⁸ to 10¹⁰ (poise) at 900 to 1,000° C. and it is considered that the contact of alumina particles is accelerated by the capillary force of the fused solution.

Examples of the vanadium oxide for use in the present invention include VO, V₂O₃, VO₂ and V₂O₅. Among these, V₂O₅ is preferred.

In the production of the alumina-based ceramic material of the present invention, for example, the amount of the manganese and titanium composite oxide added is from 6 to 11 mass %, preferably from 7 to 9 mass % based on the total mass of the material. For example, the amount of the vanadium oxide added is from 2 to 6 mass %, preferably from 2.5 to 4.5 mass % based on the total mass of the material. If the amount of the manganese and titanium composite oxide added is less than 6 mass %, the sintering may not proceed at the predetermined temperature, whereas if it exceeds 11 mass %, the properties of the sintered body may be deteriorated and at the same time, the properties analogous to the original alumina may not be obtained. If the amount of the vanadium oxide is less than 2 mass %, the sintering may not proceed at the predetermined temperature, whereas if it exceeds 6 mass %, the oxide diffuses out of the system at the sintering to cause bleeding to the setter and decrease in the mass of the sintered body and also, the properties of the original alumina may not be obtained.

The particle size of the alumina for use in the starting material is preferably 1 μm or less, more preferably from 0.3 to 0.6 μm. If the particle size of the alumina is less than 0.3 μm, the mixing or shaping may become difficult, whereas if it exceeds 1 μm, the sintering retardedly proceeds at the predetermined temperature.

The BET specific surface area of the manganese-titanium composite oxide for use in the starting material is preferably 1 m²/g or more, more preferably 2 m²/g to 100 m²/g, most preferably 2 m²/g to 50 m²/g. The finer the manganese-titanium composite oxide particle, the more preferable. If the specific surface area is less than 1 m²/g, the sintering retardedly proceeds at the predetermined temperature. If the specific surface area is more than 100 m²/g, it may be difficult to handle the particle.

The particle size of the vanadium oxide for use in the starting material is preferably from 0.5 to 3 μm, more preferably from 0.5 to 1.5 μm. The finer the particle size of the vanadium oxide, the more preferable. If the particle size exceeds 3 μm, the sintering retardedly proceeds at the predetermined temperature.

In the present invention, an oxide or the like of an alkaline earth metal such as Ca may be added to the starting material in an amount of about 2 mass % or less for the purpose of decreasing the dielectric loss of the ceramic material.

In the production method of the present invention, for example, alumina and the starting material comprising a manganese-titanium composite oxide and a vanadium oxide are thoroughly mixed. The grinding step may be carried out before mixing the above of the composite oxide. At this time, a grinding aid is preferably added to the mixed starting material for the purpose of preventing packing of the particles or the like, in other words, preventing the fine powder particles from attaching to the mill. Examples of the grinding aid usable in the present invention include conventionally used compounds such as alcohol-based ones, amine-based ones, carboxylic-acid-based ones. Specifically, preferable examples thereof include glycerine, benzene, εcaprolactam, acrylamide, ethylene glycol, methanol, ethanol, diethylene glycol, propylene glycol, buthanediol, calcium stearate, stearic amide, oleic acid, acetic acid, dedecylamine chloride, triethanol amine, cationic detergent and water. Among these, ethylene glycol is particularly preferred.

In the production method of the present invention, for example, the starting material after mixed and ground is charged into a metal mold having an appropriate size and shaped by using a pressurizing press to obtain a shaped article. In this case, it is preferred that the mixed starting material is, for example, wet ground, the resulting slurry is formed into granules while drying with a spray dryer or the like, and the granules are shaped by using a pressurizing press. Thereafter, the shaped article is sintered by elevating the temperature in an electric furnace or the like. The sintering temperature is preferably within a range of 900 to 1,100° C., more preferably 950 to 1,050° C. If the sintering temperature is less than 900° C., the sintering may not proceed, whereas if it exceeds 1,100° C., a conductor such as Ag or Cu cannot be used in the shaped article and this is not preferred. The sintering time is preferably within a range of 1 to 8 hours.

The alumina-based ceramic material in the present invention can be sintered at a low temperature and therefore, a conductor having low resistance, such as Ag or Cu, can be used and simultaneously fired. For example, by printing a wiring pattern on the shaped article with a wiring conductor paste containing Ag or Cu and then firing it, a wiring substrate formed of the ceramic material can be produced. At this time, by allowing the wiring substrate to be comprised of a plurality of layers, the substrate may have a multilayer wiring structure.

A dielectric antenna, a dielectric resonator, a supporting stand thereof, a dielectric filter and a duplexer for use in a communication device, each using the ceramic material in the present invention, and a communication device are described below by referring to the drawings for purposes of illustration. Here, the equipments shown in the Figures are merely one example and each equipment in the present invention is not limited to the configuration shown in the Figures.

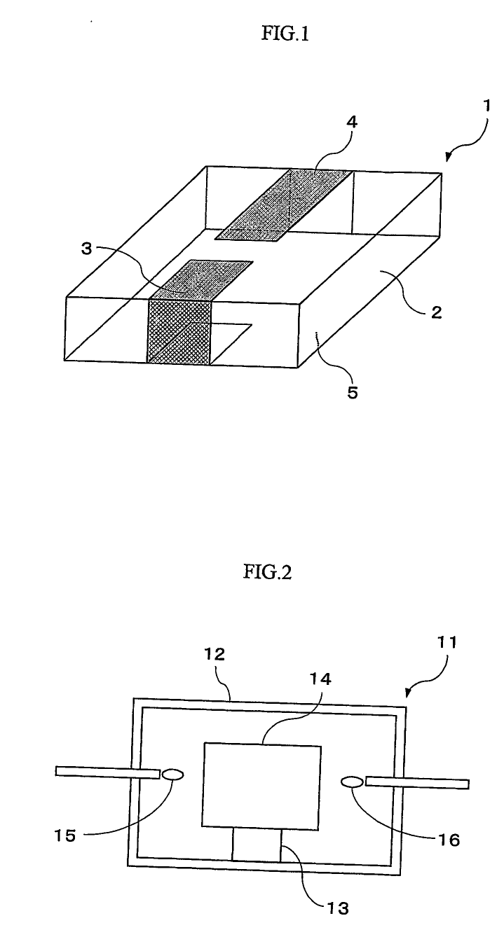

FIG. 1 is a perspective view showing one example of the dielectric antenna of the present invention. The dielectric antenna 1 comprises an antenna substrate 2 in the shape of a rectangular parallelepiped, where an input electrode 3 is formed at the end part in the front side of the antenna substrate 2, a radiation electrode 4 is linearly formed on the top center part of the antenna substrate 2 while keeping a predetermined distance from the input electrode 3, a ground electrode 5 is formed nearly throughout the bottom surface of the antenna substrate 2, and the ground electrode 5 is electrically connected to the radiation electrode 4. This antenna substrate 2 constituting the dielectric antenna 1 can be formed by using the alumina-based ceramic material of the present invention.

FIG. 2 shows one example of the arrangement plan of the dielectric resonator using the supporting stand of the present invention. The dielectric resonator 11 comprises a metal case 12 and in the space inside the metal case 12, a columnar dielectric porcelain 14 supported by a supporting stand 13 is disposed. Also, an input terminal 15 and an output terminal 16 are held by the metal case 12. In such a dielectric resonator 11, the supporting stand 13 for supporting the dielectric porcelain 14 can be formed by using the alumina-based ceramic material of the present invention.

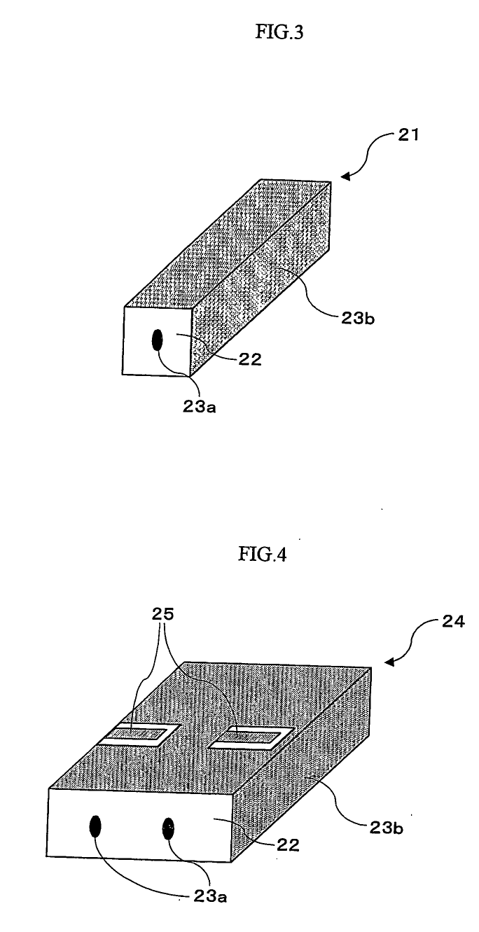

FIG. 3 is a perspective view showing one example of the resonator using the dielectric porcelain of the present invention. The dielectric resonator 21 comprises a square-columnar dielectric porcelain 22 having a through-hole, where an inner conductor 23a is formed inside the through-hole and an outer conductor 23b is formed in the periphery. When the dielectric porcelain 22 is coupled via electromagnetic field to an input/output terminal, namely, external connection means, the dielectric resonator is actuated. The dielectric porcelain 22 constituting this dielectric resonator 21 can be formed by using the alumina-based ceramic material of the present invention.

FIG. 4 is a perspective view showing one example of the dielectric filter of the present invention. In the dielectric filter 24, external connection means 25 are formed on a dielectric resonator comprising a dielectric porcelain 22 having a through-hole, where an inner conductor 23a and an outer conductor 23b are formed. This dielectric porcelain 22 can be formed by using the alumina-based material of the present invention.

FIG. 5 is a perspective view showing one example of the dielectric duplexer of the present invention. The dielectric duplexer 26 comprises two dielectric filters each equipped with a dielectric resonator comprising a dielectric porcelain 22 having a through-hole, where an inner conductor 23a and an outer conductor 23b are formed, input connecting means 27 connected to one dielectric filter, output connecting means 28 connected to the other dielectric filter, and antenna connecting means 29 commonly connected to these dielectric filters. The dielectric porcelain 22 can be formed by using the alumina-based material of the present invention.

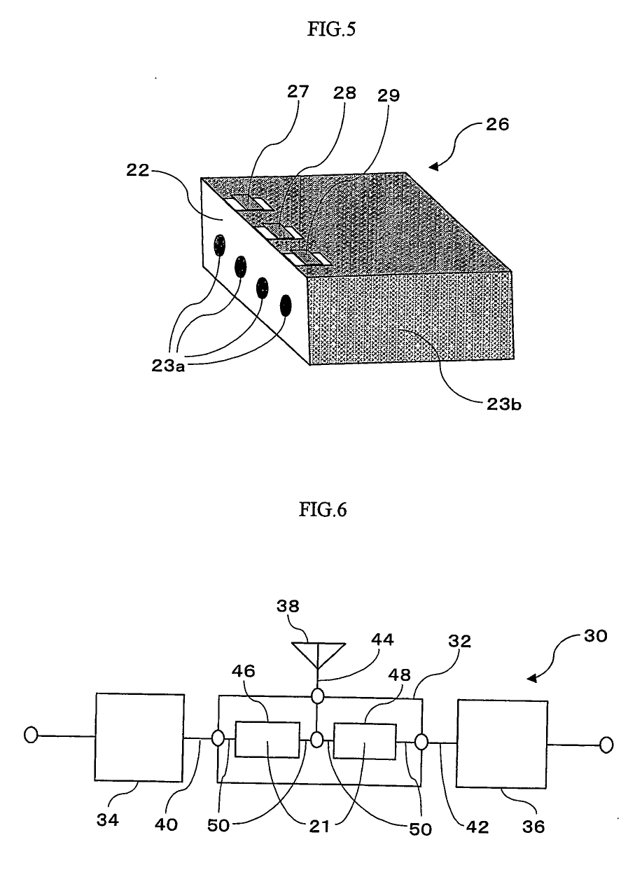

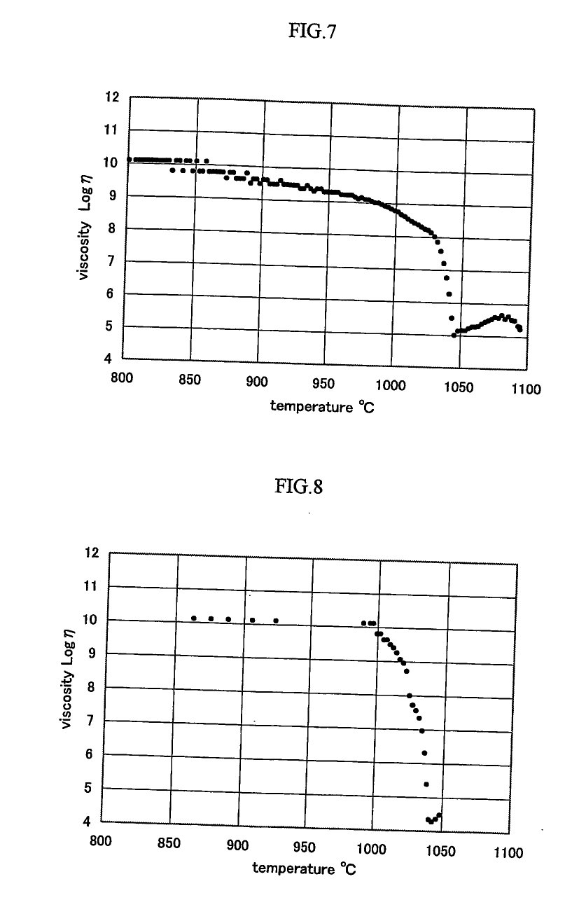

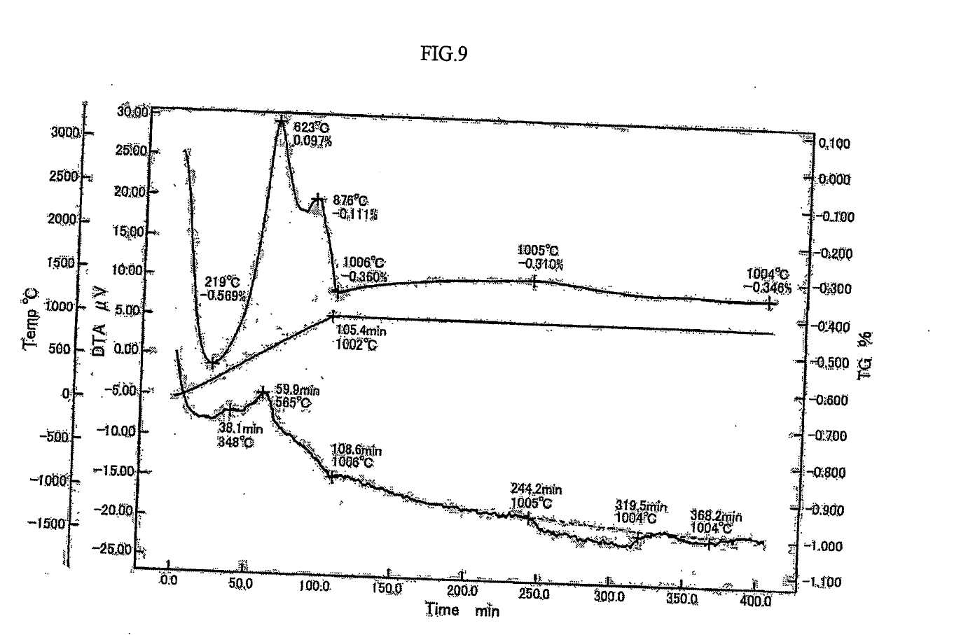

FIG. 6 is a block diagram showing one example of the communication device of the present invention. The communication device 30 comprises a dielectric duplexer 32, a transmission circuit 34, a receiving circuit 36 and an antenna 38. The transmission circuit 34 is connected to the input connecting means 40 of the dielectric duplexer 32 and the receiving circuit 36 is connected to the output connecting means 42 of the duplexer 32. For this dielectric duplexer 32, the dielectric duplexer shown in FIG. 6 can be used. The antenna 38 is connected to antenna connecting means 44 of the dielectric duplexer 32. The dielectric duplexer 32 contains two dielectric filters 46 and 48. The dielectric filters 46 and 48 each comprises the dielectric resonator of the present invention having connected thereto external connection means. In the dielectric resonator 21, the input/output terminal is connected to the external connection means 50.

The alumina-based ceramic material of the present invention can be widely used not only for the above-described devices such as dielectric antenna and dielectric resonator but also for high-frequency devices such as circuit board for use in the microwave to milliwave band.

### BEST MODE FOR CARRYING OUT THE INVENTION

The present invention is described in greater detail below by referring to Examples, however, the present invention is not limited to these Examples.

### EXAMPLES 1 TO 14 AND COMPARATIVE EXAMPLES 1 to 5

As starting materials, alumina (average particle size (hereinafter, simply referred to as “particle size”): 0.5 μm, density: 3.98 g/cm³), MnTiO₃ (Product code: MNF05PA, manufactured by Kojundo Chemical Laboratory Co., Ltd., BET specific surface area: 2.68 m²/g, particle size: 0.14 μm, density: 4.55 g/cm³), V₂O₅ (particle size: 0.8 μm, density: 3.35 g/cm³), MnO (particle size: 1.1 μm, density: 5.18 g/cm³) and TiO₂ (particle size: 0.54 μm, density: 4.26 g/cM³) were used. These starting materials were mixed at a ratio shown in Table 1 and ground in a dry system by using a planetary ball mill (Product Model P-5/4, manufactured by Fritsch) to prepare the mixed material for Examples 1 to 14 and Comparative Examples 1 to 5. At the mixing, a grinding aid (ethylene glycol) was added in an amount of 0.5 mass % based on the starting material powder. The mixing-grinding conditions were 200 revolutions/min and a mixing·grinding time of 10 minutes. The mixed-ground powder was charged into a metal mold and then pressure-shaped under a pressure of 98 MPa to produce a columnar-shaped article of about 2.5 cmφ. This shaped article was sintered at a temperature-rising rate of 600° C./hour and a sintering temperature of 1,000° C. for a sintering time of 5 hours. The relative density (RD) of the alumina-based ceramic material after sintering is shown in Table 1.

In order to examine the viscosity of the sintering aid in a high-temperature molten state, an article shaped to have a diameter of 7 mmφ and a height of 6 mm was measured as a sample by using a parallel plate pressure viscometer (Product Model:PPVM-1100, manufactured by OPT Corp.). The results on the sintering aid in Example 12 are shown in FIG. 7 and the results on the sintering aid in Comparative Example 5 are shown in FIG.

### EXAMPLES 15 TO 18

To a mixed powder obtained by the production method of Examples 10, 11, 13 and 14 and Comparative Example 5, 3 mass % of acrylic resin as the binder, 1 mass % of glycerin as the plasticizer and water in an amount of giving a concentration of 50 mass % were added. Then, these were mixed and kneaded in a ball mill for 1 hour to produce a slurry. The produced slurry was dried and thereby granulated in Model DCR-2 Disc Atomizer-Type Spray Dryer manufactured by Sakamoto Giken. The resulting granules were charged into a metal mold and press-shaped under a pressure of 98 MPa to produce a columnar-shaped article of about 2.5 cmφ.

This shaped article was sintered at a temperature-rising rate of 600° C./hour and a sintering temperature of 1,000° C. for a sintering time of 5 hours. The resulting sintered body was worked and used for the measurement of dielectric properties.

For the measurement frequency of 1 GHz, the sintered body was worked to 1.500±0.005 mm square×80 mm and for 5 GHz, 1.500±0.005 mm square×70 mm. The thus-worked shaped article was vacuum-dried at 120° C. for 2 hours and left standing in a room under constant temperature and constant humidity conditions for 1 day. After this treatment, the sintered body was measured on the dielectric constant and dielectric loss at measurement frequencies of 1 GHz and 5 GHz by using Network Analyzer Model 8753ES manufactured by Agilent Technologies.

Also, the strength was measured based on JISR1601. The sintered body after the working was measured on the three-point bending strength by using Model UCT-LT manufactured by Orientec.

The results in the measurement of relative density, strength and dielectric properties of each sintered body in Examples 15 to 18 and Comparative Example 6 are shown in Table 2.

TABLE 1

| | Starting Material | | | | | |
|---|---|---|---|---|---|---|
| | MnTiO₃ | V₂O₅ | MnO | TiO₂ | | |
| | (%) | (%) | (%) | (%) | Al₂O₃ | RD |
| Example 1 | 8.0 | 3.0 | — | — | bal. | 95.3 |
| Example 2 | 8.0 | 3.5 | — | — | bal. | 95.6 |
| Example 3 | 8.0 | 4.0 | — | — | bal. | 96.6 |
| Example 4 | 8.5 | 3.0 | — | — | bal. | 94.5 |
| Example 5 | 8.5 | 3.5 | — | — | bal. | 96.0 |
| Example 6 | 8.5 | 4.0 | — | — | bal. | 96.2 |
| Example 7 | 8.5 | 4.5 | — | — | bal. | 95.9 |
| Example 8 | 9.0 | 3.0 | — | — | bal. | 94.7 |
| Example 9 | 9.0 | 3.5 | — | — | bal. | 96.1 |
| Example 10 | 9.0 | 4.0 | — | — | bal. | 96.4 |
| Example 11 | 9.0 | 4.5 | — | — | bal. | 95.7 |
| Example 12 | 9.0 | 5.0 | — | — | bal. | 95.8 |
| Example 13 | 10.0 | 4.0 | — | — | bal. | 96.2 |
| Example 14 | 10.0 | 5.0 | — | — | bal. | 95.9 |
| Comparative | — | 3.0 | 4.0 | 4.0 | bal. | 91.9 |
| Example 1 | | | | | | |
| Comparative | — | 3.5 | 4.0 | 4.0 | bal. | 93.3 |
| Example 2 | | | | | | |
| Comparative | — | 4.0 | 4.0 | 4.0 | bal. | 93.9 |
| Example 3 | | | | | | |
| Comparative | — | 4.5 | 4.0 | 4.0 | bal. | 90.7 |
| Example 4 | | | | | | |
| Comparative | — | 5.0 | 4.5 | 4.5 | bal. | 95.2 |
| Example 5 | | | | | | |

Measurement Method of Relative Density (RD):

The RD was calculated according to the following formula:

RD=sintered bulk density/theoretical density

Theoretical density=1/Σ(w/p)

wherein

ρ: density (g/cm³) of oxide as starting material

w: mass fraction of oxide as starting material (assuming that 100 mass % is 1).

Differential Thermal Analysis:

Differential Thermal Analyzer SSC220 manufactured by Seiko Corporation was used. After the temperature was elevated to 1,000° C. at a temperature-rising rate of 10° C./min, the measurement was performed under the temperature condition of holding the sample at 1,000° C. for 5 hours. FIG. 9 shows the TG-DTA curve measured for the sintering aid of Example 12.

X-Ray Diffraction Measurement:

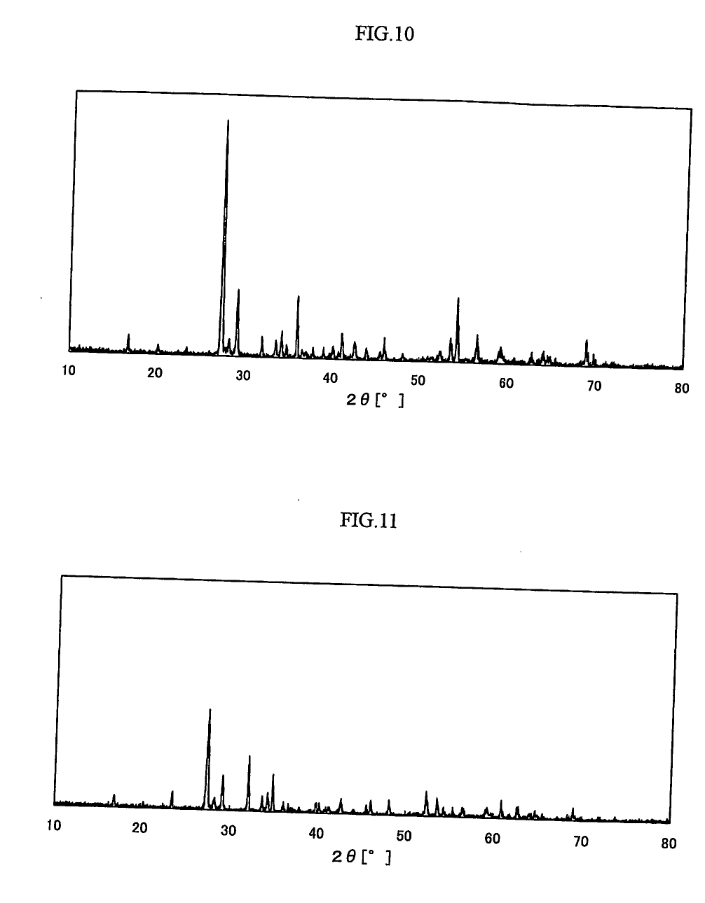

An X-ray diffraction apparatus manufactured by Rigaku Corporation was used while employing RU-200B as the X-ray generator and Rad-B as the goniometer. By using CuKα ray as the X-ray source and graphite as the monochrometer, an X-ray diffraction pattern at an output of 50 kV and 180 mA and a slit width of ½-½-0.15 mm was measured at a scanning speed of 5°/min and a step of 0.02°. FIG. 10 shows the X-ray diffraction pattern measured for the sintering aid of Example 12 after the sample was held at 1,000° C. for 5 hours and then cooled. The diffraction peaks attributable to the TiO₂ crystal phase at d₁₁₀, d₁₀₁, d₂₀₀, d₁₁₁, d₂₁₁ and d₂₂₀ were detected in the vicinity of 2θ=27°, 36°, 39°, 41°, 54° and 57° respectively, the diffraction peaks attributable to the MnTiO₃ crystal phase at d₀₁₂, d₁₀₄ and d₁₁₀ were detected in the vicinity of 2θ=24°, 32° and 35° respectively, the d₂₀₁ diffraction peak attributable to the VO₂ crystal phase was detected in the vicinity of 2θ=28°, and the diffraction peaks attributable to the Mn₂V₂O₇ crystal phase at d₁₁₀, d₂₀₁, d₁₃₀, d₃₁₁, d₂₂₂ and d₁₃₂ were detected in the vicinity of 2θ=17°, 29°, 34°, 43°, 46° and 54° respectively.

The peak intensity (peak height) in the vicinity of 29° attributable to the Mn₂V₂O₇ crystal phase of the sample was about 4 times the peak intensity (peak height) in the vicinity of 32° attributable to the MnTiO₃ crystal phase.

On the other hand, the results of the X-ray Diffraction measurement made on the sintering aid of Comparative Example 5 in the same measuring manner as above are shown in FIG. 11. The peak intensity (peak height) in the vicinity of 29° attributable to the Mn₂V₂O₇ crystal phase at d₂₀₁ was about 0.7 times the peak intensity (peak height) in the vicinity of 32° attributable to the MnTiO₃ crystal phase at d₁₀₄.

TABLE 2

| | Starting Material | | | | Three-Point | Dielectric Constant, | Dielectric Loss, |
|---|---|---|---|---|---|---|---|
| | MnTiO₃ | V₂O₅ | | | Bending, | @1 GHz | @1 GHz |
| | (%) | (%) | Al₂O₃ | RD | MPa | @5 GHz | @5 GHz |
| Example 15 | 9.0 | 4.0 | bal. | 96.4 | 243 | 10.9 | 0.002 |
| | | | | | | 11.5 | 0.002 |
| Example 16 | 9.0 | 5.0 | bal. | 95.8 | 250 | 10.9 | 0.001 |
| | | | | | | 11.5 | 0.002 |
| Example 17 | 10.0 | 4.0 | bal. | 96.2 | 214 | 10.9 | 0.001 |
| | | | | | | 11.5 | 0.001 |
| Example 18 | 10.0 | 5.0 | bal. | 95.9 | 250 | 11.4 | 0.007 |
| | | | | | | 12.0 | 0.001 |
| Comparative | | | | 95.2 | | 11.8 | 0.012 |
| Example 6 | | | | | | 12.0 | 0.015 |

### INDUSTRIAL APPLICABILITY

According to the present invention, a sintered shaped article of the ceramic material mainly comprising alumina having a high density can be obtained even by sintering at a low temperature. When this shaped article is used for a substrate or the like, excellent properties such as large thermal conductivity and small dielectric loss can be attained. Further according to the present invention, conductor material such as Ag or Cu enabling fine-pattering can be sintered simultaneously. Therefore, this shaped article can be widely used for devices such as wiring substrate, dielectric antenna and dielectric resonator, or for high-frequency devices such as circuit board used in the microwave to milliwave band.

1. A method for producing an alumina-based ceramic material comprising alumina as the main component, comprising mixing a manganese and titanium composite oxide and a vanadium oxide with the main component alumina, shaping the mixture and sintering the resulting shaped article.

2. A method for producing an alumina-based ceramic material comprising alumina as the main component, comprising mixing a manganese and titanium composite oxide and a vanadium oxide with the main component alumina, granulating the mixture, shaping the granules and sintering the resulting shaped article.

3. The method for producing an alumina-based ceramic material as claimed in claim 1, wherein the manganese-titanium composite oxide comprises MnTiO₃.

4. The method for producing an alumina-based ceramic material as claimed in claim 1, wherein the vanadium oxide comprises V₂O₅.

5. The method for producing an alumina-based ceramic material as claimed in claim 1, wherein an alumina material having an average particle size of 0.3 to 1 μm is used.

6. The method for producing an alumina-based ceramic material as claimed in claim 1, wherein the manganese-titanium composite oxide has a BET specific surface area of 1 m²/g or more.

7. The method for producing an alumina-based ceramic material as claimed in claim 1, wherein the vanadium oxide has an average particle size of 0.5 to 3 μm.

8. The method for producing an alumina-based ceramic material as claimed in claim 1, wherein the mixing is carried out with a grinding aid.

9. The method for producing an alumina-based ceramic material as claimed in claim 1, wherein the amount of the manganese-titanium composite oxide added is within a range of 6 to 10 mass % and the amount of the vanadium oxide added is within a range of 2 to 5 mass % based on the total mass of the material.

10. The method for producing an alumina-based ceramic material as claimed in claim 1, wherein the alumina-based ceramic material comprises an oxide of an alkaline earth metal in an amount of 2 mass % or less % based on the total mass of the material.

11. The method for producing an alumina-based ceramic material as claimed in claim 1, wherein the sintering temperature is within a range of 900 to 1,100° C.

12. The method for producing an alumina-based ceramic material as claimed in claim 1, wherein the sintering is performed after a circuit is wired with Ag or Cu on the surface of the shaped article.

13. An alumina-based ceramic material produced by using the production method claimed in claim 1.

14. An alumina-based ceramic material comprising Mn₂V₂O₇ crystal phase.

15. The alumina-based ceramic material as claimed in claim 14, comprising MnTiO₃ crystal phase.

16. The alumina-based ceramic material as claimed in claim 14, comprising VO₂ crystal phase.

17. The alumina-based ceramic material as claimed in claim 14, comprising TiO₂ crystal phase.

18. An alumina-based ceramic material comprising alumina as the main component, comprising crystal phases of MnTiO₃, VO₂ and TiO₂.

19. The alumina-based ceramic material as claimed in claim 15, wherein the crystal phase measured by the X-ray diffraction measurement, the d₂₀₁ peak intensity of Mn₂V₂O₇ in the vicinity of 2θ=29° is larger than the d₁₀₄ peak intensity of MnTiO₃ in the vicinity of 2θ=32°, in the Cu-Kα ray diffraction peak.

20. The alumina-based ceramic material as claimed in claim 14, wherein the relative density of the alumina-based ceramic material is 94% or more at sintering temperature of 1,000° C.

21. The alumina-based ceramic material as claimed in claim 14, wherein the melt viscosity of the alumina-based ceramic material is from 10⁸ to 10¹⁰ (poise) in the temperature region of 900 to 1,000° C.

22. The alumina-based ceramic material as claimed in claim 14, wherein the endothermic peak of the alumina-based ceramic material is detected in the vicinity of 1,000° C. (retain) in differential thermal analysis.

23. A multilayer wiring substrate comprising an insulating layer formed of the alumina-based ceramic material claimed in claim 13, and a copper (Cu) or silver (Ag) conductor.

24. A dielectric porcelain comprising the alumina-based ceramic material claimed in claim 13.

25. A dielectric antenna comprising the alumina-based ceramic material claimed in claim 13, the alumina-based ceramic material having on the surface thereof a radiation electrode and a ground electrode

26. A dielectric resonator comprising a dielectric porcelain disposed on a supporting stand formed of the alumina-based ceramic material claimed in claim 13, and an input/output terminal disposed by electromagnetic-field connection in both sides of the dielectric porcelain.

27. A dielectric filter for communication devices, using the dielectric porcelain claimed in claim 24.

28. A dielectric duplexer comprising at least two dielectric filters, input/output connecting means connected to each dielectric filter, and antenna connecting means commonly connected to the dielectric filters, wherein at least one of the dielectric filters is the dielectric filter claimed in claim 27.

29. A communication device comprising a dielectric duplexer, a transmission circuit connected to at least one input/output connecting means of the dielectric duplexer, a receiving circuit connected to at least one input/output connecting means different from the input/output connecting means connected to the transmission circuit, and an antenna connected to the antenna connecting means of the dielectric duplexer, wherein the dielectric duplexer is the dielectric duplexer claimed in claim 28.
